(19) United States
(12) Patent Application Publication
(10) Pub. No.: US 2026/0343394 A1
(43) Pub. Date: Oct. 29, 2026

(54) MAINTAINING 5G STANDALONE CONNECTIVITY WHEN ESTABLISHING A WIFI CONNECTION

(71) Applicant: T-Mobile USA, Inc., Bellevue, WA (US)

(72) Inventor: Hang Hoi Yau, Sammamish, WA (US)

(21) Appl. No.: 19/189,245

(22) Filed: Apr. 24, 2025

(51) Int. Cl. H04W 48/18; H04W 8/18; H04W 60/04

(52) U.S. Cl. CPC H04W 48/18; H04W 8/183; H04W 60/04

(57) ABSTRACT

Systems and methods are provided for allowing a wireless device to maintain 5G standalone (SA) connectivity when establishing a WiFi connection. Some wireless devices are configured to automatically disable 5G SA connectivity when connecting to a WiFi network, preventing the device from simultaneously using 5G SA features, such as network slicing. A device can detect that one or more network slices are available via a 5G SA connection. When the device then attaches to a WiFi connection, the device can detect that it is configured to automatically disable 5G SA connectivity, and in response, prevent 5G SA connectivity from being disabled. The device can then maintain a 5G SA connection and use network slicing via the 5G SA connection.

### BACKGROUND

5G networks provide enhanced mobile broadband capabilities, massive machine-type communications, and ultra-reliable low-latency communications. These networks utilize advanced technologies such as network slicing, which allows the creation of multiple virtual networks on a shared physical infrastructure. Network slicing enables operators to tailor network characteristics to specific use cases or customer requirements.

User equipment (UE) in 5G networks can connect to both cellular and Wi-Fi networks simultaneously. When a UE connects to a Wi-Fi network, it may change its cellular connection configuration to optimize resource usage. This can involve transitioning from standalone (SA) mode, which uses only 5Ginfrastructure, to non-standalone (NSA) mode, which utilizes both 4Gand 5Gcomponents. The specific behavior of UEs when connecting to Wi-Fi can vary based on manufacturer settings and network operator policies.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example network slicing system in a 5G network.

FIG. 4 is a flowchart that illustrates a process for maintaining 5G standalone connectivity when a user equipment establishes a WiFi connection.

FIG. 5 is a flowchart that illustrates a method for maintaining 5G standalone connectivity by a wireless device when connecting to WiFi.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to maintaining 5G standalone (SA) connectivity and network slicing capabilities when a wireless device connects to a WiFi network. Wireless devices connected to a cellular network, such as a 4Gor 5G network, can establish a WiFi connection while maintaining connection to the cellular network. This can include maintaining features of the cellular connection, such as 5G SA, in which the cellular connection relies only on 5G infrastructure without using 4G or LTE components. However, some devices are configured to automatically disable 5G SA connectivity when connecting to WiFi, and may transition from 5GSA mode to non-standalone (NSA) connectivity or to a 4G/LTE network connection. This can allow the network to reallocate 5G resources that otherwise might be unused if the device transfers most of its data through the WiFi connection rather than the cellular connection. However, certain 5G features, such as 5G network slicing, require the device to be configured for 5G SA. Therefore, such devices are not able to utilize 5G network slicing while attached to a WiFi connection.

As described in more detail below, the disclosed technology allows a device to prevent the automatic disabling of 5G SA connectivity. As an example, when a device connects to a 5G network service, it can receive Network Slice Selection Assistance Information (NSSAI) from the network, which can indicate that network slicing is available for the device. If so, the device can prevent itself from automatically disabling 5G SA connectivity when establishing a subsequent WiFi connection. This allows the device to maintain its 5G SA connection and utilize network slicing capabilities while also using the WiFi connection. Alternatively, if 5G network slicing is not available, the device can continue to automatically disable 5G SA connectivity when establishing a WiFi connection.

In one implementation, a computer-implemented method for establishing 5G network slicing on a UE configured to automatically disable 5G SA connectivity when establishing a WiFi connection can include several steps. The UE can receive network slice selection assistance information (NSSAI) from a wireless telecommunications network. The UE can detect a WiFi connection while concurrently registered to a 5G service of the wireless telecommunications network. In response to detecting the WiFi connection and receiving the NSSAI, the UE can prevent itself from disabling 5G SA connectivity. The UE can then establish network slicing with the 5G service.

In another implementation, a UE can include hardware and software components to perform several operations based on a set of instructions. The UE can receive an indication from a wireless telecommunications network that a 5G network slicing configuration is available. The UE can establish a WiFi connection with a WiFi node while concurrently registered to receive 5G service from the wireless telecommunications network. The UE can detect that it is configured to automatically disable 5G SA connectivity in response to establishing the WiFi connection. Based on receiving the network slicing configuration indication, establishing the WiFi connection, and detecting the configuration to automatically disable 5G SA connectivity, the UE can be caused to be configured for 5G SA connectivity.

In a further implementation, a non-transitory computer-readable storage medium can include instructions recorded thereon that, when executed, cause a system to perform several actions. The system can receive an indication from a wireless telecommunications network that a 5G network slicing configuration is available for use by a UE. The system can establish a WiFi connection between the UE and a WiFi node. The system can detect that the UE is configured to automatically disable 5G SA connectivity in response to establishing the WiFi connection. In response to this detection, the system can cause the UE to be configured for 5G SA connectivity.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

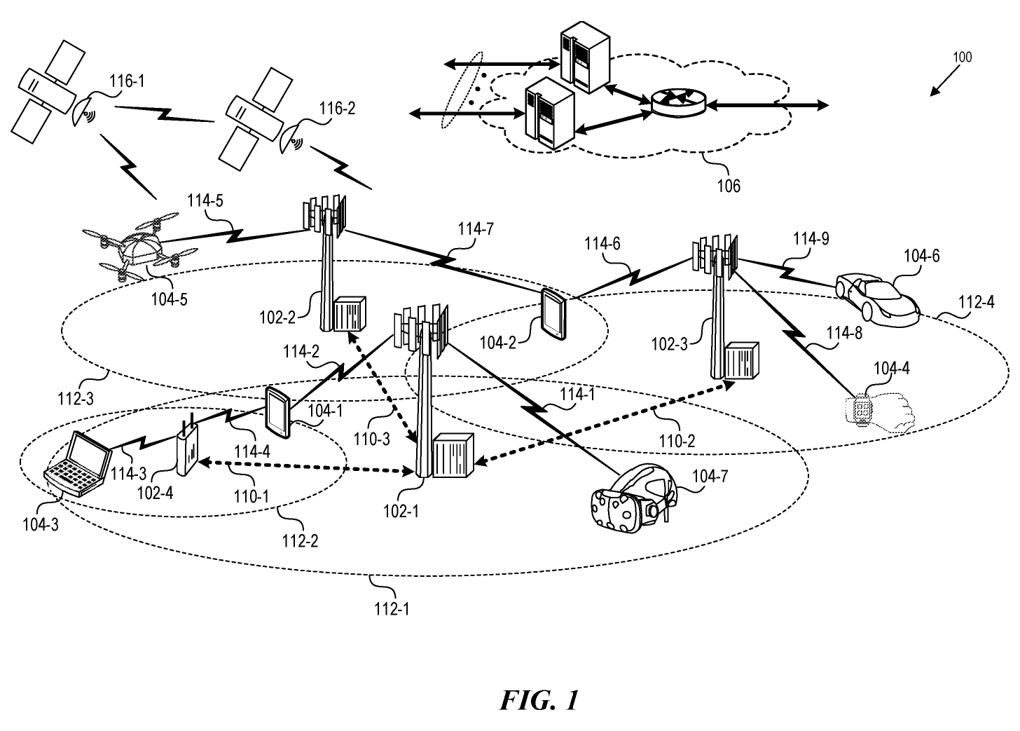

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

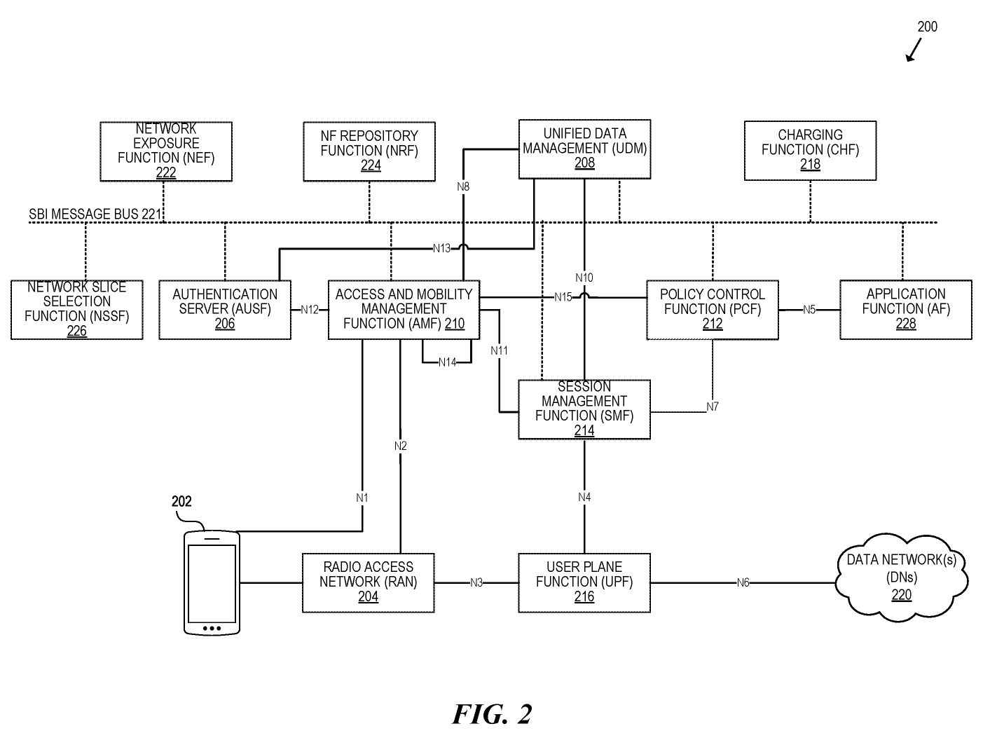

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Network Slicing System

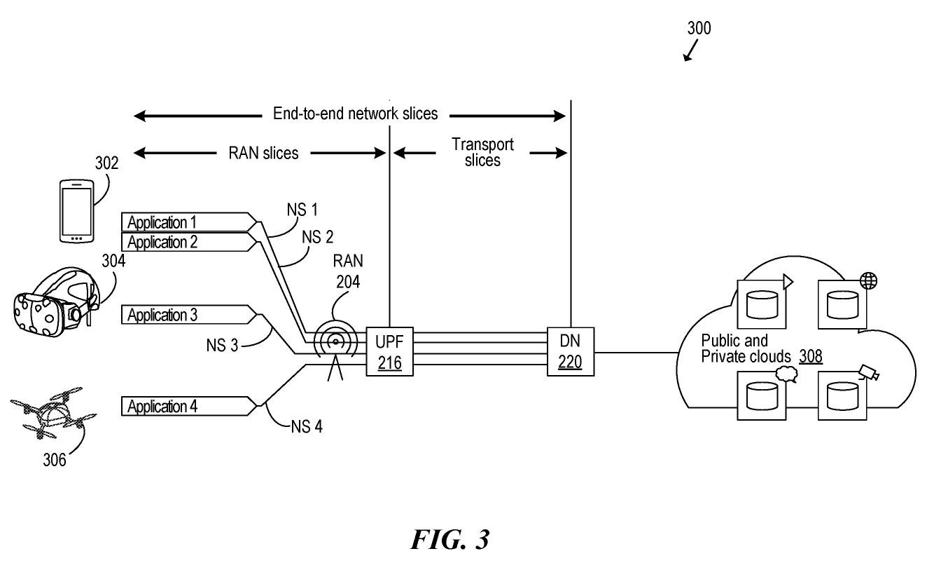

FIG. 3 is a block diagram that illustrates an example network slicing system 300 in a 5Gnetwork. The network slicing system 300 enables multiplexing of virtualized and independent logical networks (i.e., network slices NS1 through NS4) on the same physical network infrastructure. In 5G wireless networks, network slicing assumes a central role designed to efficiently embrace multiple services with very different service-level requirements (e.g., data transfer speed, reliability, bandwidth). The end-to-end network slices can be defined between wireless devices (e.g., wireless devices 302, 304, and 306) and DN 220. For example, each network slice is an isolated end-to-end network tailored to fulfill diverse requirements requested by a particular application (e.g., wireless applications 1 through 4 associated with the wireless devices 302, 304, and 306). The network slicing system 300 can be in communication with public and private clouds 308. For example, the clouds 308 can include cloud servers associated with the different wireless applications 1 through 4.

An infrastructure associated with the network slicing system includes hardware and software resources, such as user equipment and/or compute-, storage- and networking-hardware equipment, as well as the services and software programs stored thereof. The infrastructure can be used to implement physical network nodes and/or to define a distributed cloud environment, such as Physical Network Functions (PNFs) and/or the Network Functions Virtualization Infrastructure (NFVI). The infrastructure provides the support and management functionality that allows for the deployment and operation of individual network slices. The infrastructure can include a collection of PNFs. It provides the user control and application plane functionality across the different network segments, including the RAN slices between wireless devices (e.g., wireless devices 302, 304, and 306) and the UPF 216 and transport slices between the UPF 216 and DN 220.

### Maintaining 5G Standalone Connectivity When Connecting to WiFi

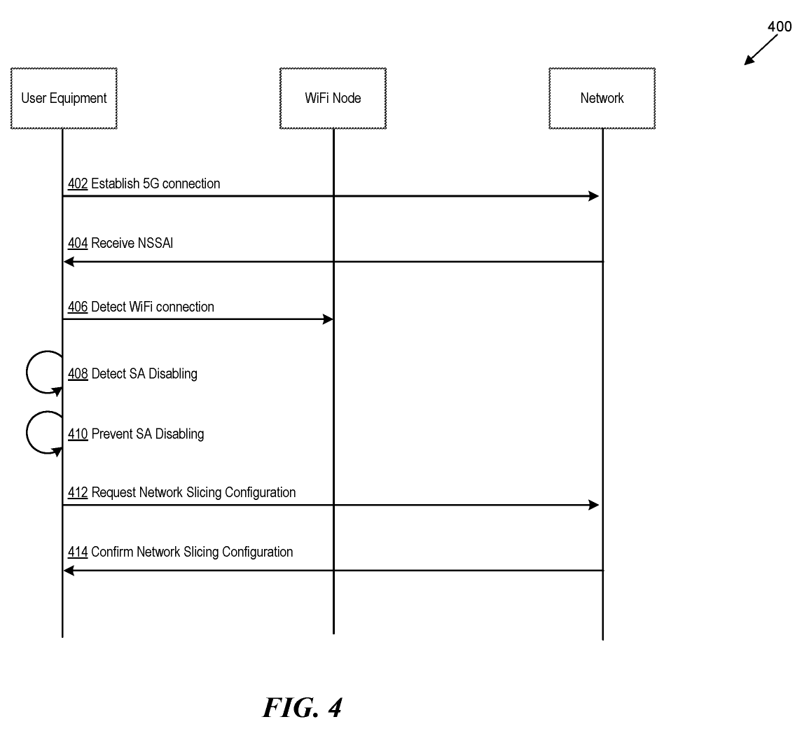

FIG. 4 is a flowchart that illustrates a process 400 for maintaining 5G SA connectivity when a user equipment (UE) establishes a WiFi connection. The process 400 as illustrated involves interactions between a UE (e.g., a wireless device 104), a 5G Core ("5GC") of a wireless telecommunications network ("the network"). In the following description for FIG. 4, actions attributed to the UE can be performed by one or more components of the UE (e.g., an application or applet executing on the UE and/or on an integrated circuit, such as a subscriber identity module (SIM) coupled to the UE).

5G SA describes a network that relies only on 5G standards and protocols (e.g., radio resources, gNodeB (gNB), 5GC). A device using 5G SA connection directly connects to the 5GC, enabling end-to-end 5G services and capabilities, such as 5G network slicing. In contrast, 5G non-standalone (NSA) describes a hybrid network using 5G and 4G resources. For example, a 5G NSA network can use 5G radio equipment (e.g., such as gNBs), but use 4G/LTE resources for control plane functions (e.g., by using a 4G/LTE core, such as an Evolved Packet Core (EPC)). This can allow for some benefits of a 5G network, such as improvements in speed, but can prevent a connected device from accessing all of the features of a 5G SA network, such as network slicing.

Some devices can be configured to automatically disable 5G SA connectivity when establishing a WiFi connection. Because a device attached to WiFi can require fewer cellular network resources due to traffic being directed over WiFi, disabling 5G SA connectivity (e.g., using a 5G NSA connection) can release 5G resources for use by other devices. However, if network slicing is only available with 5G SA, this can prevent the device from utilizing network slicing while connected to WiFi.

At 402, the UE can establish a 5G connection with the network (e.g., with the 5GC). The UE can have 5G SA connectivity and/or be configured to establish a 5G SA connection with the network.

At 404, the UE can receive Network Slice Selection Assistance Information (NSSAI) from the network. An NSSAI is a collection of Single Network Slice Selection Assistance Information (S-NSSAI), where each S-NSSAI identifies a specific network slice. Receiving the NSSAI can be part of the signaling during the setup of the 5G SA connection. For example, the UE can include a network slicing request while registering with the network (e.g., a Registration Request message including a Requested NSSAI information element, which can notify the network of one or more network slices, identified by S-NSSAI, that the UE would like to use), and the network can respond with NSSAI data (e.g., a Registration Accept message including an Allowed NSSAI information element, which can indicate network slices that the UE is permitted to use, and/or a Configured NSSAI element, which can indicate network slices that are configured for use by the UE).

At 406, the UE can establish a WiFi connection with a WiFi node. The WiFi node can be an internet router, mobile hotspot, or any other device that offers WiFi connectivity. The UE can attach to the WiFi node while connected to the 5G service(s) of the network (e.g., one or more network slices). In some implementations, the UE will remain registered to the 5G service(s) of the network, but will prioritize using the WiFi connection to send and receive data.

At 408, the UE can detect that the UE is configured to automatically disable 5G SA connectivity when using a WiFi connection . In some implementations, the UE is configured (e.g., by an original equipment manufacturer (OEM)) to disable 5G SA connectivity when attaching to WiFi. For example, the UE can be configured to, in response to detecting a WiFi connection to the UE, disable 5G SA connectivity, deregister from the 5G connection to the network, and register for a 4G/LTE connection. In another example, the UE can disable 5G SA connectivity, and use 4G/LTE components for control plane functions (e.g., use a 5G NSA connection).

At 410, the UE can prevent 5G SA connectivity from being disabled. This can be in response to a determination that the UE is registered to be able to use network slices with the network. For example, the UE can determine, based on the received NSSAI, that the UE is registered to request and/or use one or more network slices. In another example, the UE can detect that one or more network slices are configured for use by the UE and/or are currently in use by the UE.

In some implementations, preventing 5G SA connectivity from being disabled includes preventing the UE from disabling 5G SA connectivity. This can allow the UE to maintain any network slices previously configured for use by the UE. In some implementations, preventing 5G SA connectivity from being disabled involves detecting that 5G SA connectivity is disabled (e.g., in response to establishing and/or detecting a WiFi connection), and subsequently re-enabling 5G SA connectivity. This can include re-establishing an interrupted 5G service and/or one or more network slices. In some implementations, preventing 5G SA connectivity from being disabled involves disabling a configuration set by an OEM of the UE. In some implementations, preventing 5G SA connectivity from being disabled involves disabling a configuration set by one or more programs and/or an operating system (OS) of the UE.

Once the UE is simultaneously connected to the 5G SA connection and to the WiFi connection, the UE is able to request and utilize network slices with the network. For example, at 412, the UE can request a network slice with the network (e.g., by sending a Requested NSSAI with one or more S-NSSAI indicating requested network slices), the network can provision the network slice for use by the UE, and at 414, the network can confirm the network slicing configuration (e.g., by sending an Allowed NSSAI). This allows the UE to use a network slice and a WiFi connection simultaneously.

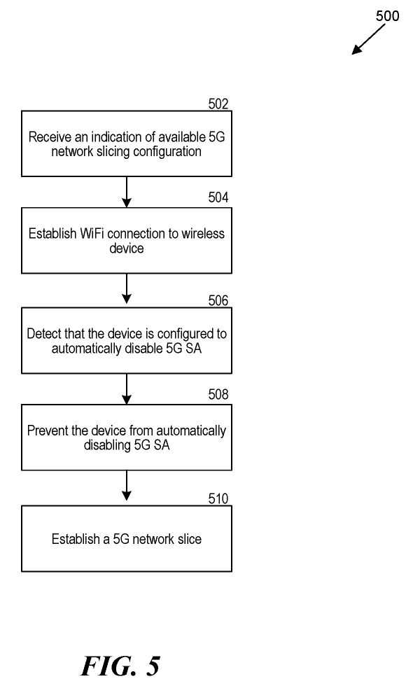

FIG. 5 is a flowchart that illustrates a method 500 for maintaining 5G SA connectivity by a wireless device ("the device") when connecting to WiFi. The method 500 can be performed by a system, such as the device (e.g., a UE and/or a wireless device 104), one or more components of the device (e.g., an application or applet executing on the UE and/or on an integrated circuit, such as a subscriber identity module (SIM) coupled to the UE), and/or one or more components of a wireless telecommunications network ("the network").

At 502, the system can receive an indication that a 5G network slicing configuration is available for use by the device. This can involve receiving the indication from the network. In some implementations, the indication includes NSSAI (e.g., an Allowed NSSAI and/or a Configured NSSAI). The NSSAI can include information about available network slices and their characteristics. The NSSAI can be received as part of registering the UE to receive services from the network. In some implementations, the indication includes subscriber information from the network (e.g., subscriber information for a user of the device). In some implementations, the indication includes a parameter accessible via the device (e.g., a configuration stored on the device and/or on a SIM card coupled to the device), such as subscriber information for a user of the device.

At 504, the system can detect a WiFi connection between the device and a WiFi node. This can involve establishing a connection between the device and the WiFi node. In some implementations, the device is concurrently registered to receive 5G service from the network and WiFi service from the WiFi node.

At 506, the system can detect that the device is configured to automatically disable 5G SA connectivity in response to establishing and/or detecting the WiFi connection. In some implementations, the UE can be configured by an OEM to automatically disable 5G SA connectivity in response to establishing and/or detecting the WiFi connection. In some implementations, the device can be configured by an OS to automatically disable 5G SA connectivity in response to establishing and/or detecting the WiFi connection (e.g., the OS of the device is configured to automatically disable 5G SA connectivity).

At 508, the system can cause the device to be configured for 5G SA connectivity. This can be in response to detecting that the UE is configured to automatically disable 5G SA connectivity. Causing the device to be configured for 5G SA connectivity can include preventing the device from disabling 5G SA connectivity and/or enabling (e.g., re-enabling) 5G SA connectivity for the device (e.g., in response to detecting that the device is not configured for 5G SA connectivity, such as when 5G SA connectivity has been automatically disabled). In some implementations, the system can detect that 5G SA connectivity has been disabled and re-enable 5G SA connectivity. Causing the device to be configured for 5G SA connectivity can involve disabling or changing a configuration set by the OEM or OS (e.g., before the configuration is used to automatically disable 5G SA connectivity). In some implementations, this involves disabling a configuration set and/or configured by an OEM and/or an OS of the device that automatically disables 5G SA connectivity when connected to WiFi.

In some implementations, the system can cause the device to be configured for 5G SA connectivity in response to one or more conditions. For example, the system can cause the device to be configured for 5G SA connectivity in response to receiving NSSAI information from the network. Additionally, or alternatively, the system can cause the device to be configured for 5G SA connectivity in response to one or more parameters (including the NSSAI). For example, the device can be configured (e.g., by a user) to cause the device to be configured for 5G SA connectivity when one or more network slices are being used (e.g., before and/or during establishing the WiFi connection), when one or more particular types of network slices are being used (e.g., Enhanced Mobile Broadband (eMBB), massive Machine Type Communications (mMTC) and/or Massive Internet of Things (Massive IoT), Ultra-Reliable Low Latency Communications (URLLC), and the like), when one or more specific applications are executing on the device and/or using one or more network slices, a subscription status associated with the device (e.g., an indication if a user of the device is subscribed to request and/or use network slices), or any combination thereof. This can involve a parameter that directs the system to always cause the device to be configured for 5G SA connectivity and/or that directs the system to never cause the device to be configured to 5G SA connectivity in response to establishing and/or detecting the WiFi connection.

At 510, the system can establish a 5G network slice for use by the device. This can involve using the received NSSAI to request and configure a specific network slice for the device. In some implementations, the system can establish a 5G network slicing configuration on the device.

In some implementations, the device is configured for 5G SA and WiFi connectivity simultaneously only for the duration of the WiFi connection. For example, the system can re-enable the automatic disabling of 5G SA connectivity (e.g., when the device disconnects from the WiFi connection and/or the 5G service). This can involve re-enabling a configuration set and/or configured by an OEM and/or an OS of the device that automatically disables 5G SA connectivity when establishing and/or detecting a WiFi connection. In some implementations, the system can allow the device to automatically disable 5G SA connectivity, such as in response to terminating the WiFi connection and/or the 5G connection (e.g., the device either disconnecting from the WiFi connection and/or disconnecting and/or de-registering with the 5G service), and/or in response to establishing a subsequent WiFi connection.

### Computer System

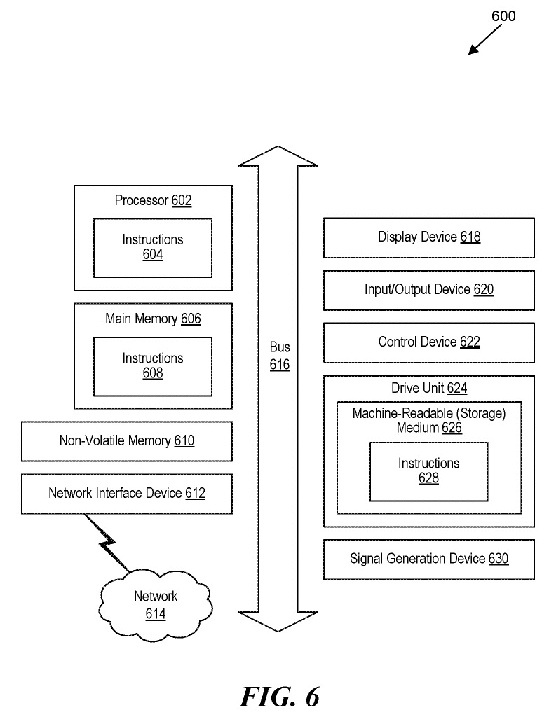

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A computer-implemented method for establishing 5G network slicing on a user equipment (UE) configured to automatically disable 5G Standalone (SA) connectivity when the UE establishes a WiFi connection, the method comprising:
receiving, from a wireless telecommunications network, network slice selection assistance information (NSSAI);
detecting a WiFi connection to the UE,
wherein the UE is concurrently registered to a 5G service of the wireless telecommunications network;
in response to detecting the WiFi connection and receiving the NSSAI, preventing the UE from disabling 5G SA connectivity; and
establishing network slicing with the 5G service on the UE.

2. The computer-implemented method of claim 1, wherein preventing the UE from disabling 5G SA connectivity comprises:
disabling a configuration set by an original equipment manufacturer (OEM) of the UE that automatically disables 5G SA connectivity when connected to WiFi.

3. The computer-implemented method of claim 1, wherein the UE is configured to automatically disable 5G SA connectivity due to an operating system (OS) configuration.

4. The computer-implemented method of claim 1, further comprising:
re-enabling automatic disabling of 5G SA connectivity when the UE disconnects from either the WiFi connection or the 5G service.

5. The computer-implemented method of claim 4, wherein re-enabling automatic disabling of 5G SA connectivity comprises:
re-enabling a configuration set by an original equipment manufacturer (OEM) of the UE that automatically disables 5G SA connectivity when connected to WiFi.

6. A User Equipment (UE) comprising:
at least one hardware processor; and
at least one non-transitory memory storing instructions, which, when executed by the at least one hardware processor, cause the UE to:
receive, from a wireless telecommunications network, an indication that a 5G network slicing configuration is available;
establish a WiFi connection between the UE and a WiFi node,
wherein the UE is concurrently registered to receive 5G service from the wireless telecommunications network and WiFi service from the WiFi node;
detect that the UE is configured to, in response to establishing the WiFi connection, automatically disable 5G Standalone (SA) connectivity; and
cause, in response to (1) receiving the indication that the 5G network slicing configuration is available, (2) establishing the WiFi connection, and (3) detecting that the UE is configured to automatically disable 5G SA connectivity, the UE to be configured for 5G SA connectivity.

7. The UE of claim 6, wherein instructions stored on the memory further cause the UE to:
establish the 5G network slicing configuration on the UE.

8. The UE of claim 6, wherein detecting that the UE is configured to automatically disable 5G SA connectivity comprises:
detecting that the UE is configured by an original equipment manufacturer (OEM) to automatically disable 5G SA connectivity.

9. The UE of claim 6, wherein detecting that the UE is configured to automatically disable 5G SA connectivity comprises:
detecting that the UE is configured by an operating system (OS) to automatically disable 5G SA connectivity.

10. The UE of claim 6, wherein causing the UE to be configured for 5G SA connectivity comprises:
detecting that 5G SA connectivity has been disabled; and
re-enabling 5G SA connectivity.

11. The UE of claim 6, wherein causing the UE to be configured for 5G SA connectivity comprises:
preventing the UE from automatically disabling 5G SA connectivity.

12. The UE of claim 11, wherein instructions stored on the memory further cause the UE to:
allow, in response to the UE either disconnecting from the WiFi connection or de-registering with the 5G service, the UE to automatically disable 5G SA connectivity in response to establishing a subsequent WiFi connection.

13. The UE of claim 6, wherein the indication that a 5G network slicing configuration is available comprises Network Slice Selection Assistance Information (NSSAI).

14. At least one non-transitory, computer-readable storage medium comprising instructions recorded thereon, wherein the instructions when executed by at least one data processor of a system, cause the system to:
receive, from a wireless telecommunications network, an indication that a 5G network slicing configuration is available for use by a user equipment (UE);
establish a WiFi connection between the UE and a WiFi node;
detect that the UE is configured to automatically disable, in response to establishing the WiFi connection, 5G Standalone (SA) connectivity; and
cause, in response to detecting that the UE is configured to automatically disable 5G SA connectivity, the UE to be configured for 5G SA connectivity.

15. The at least one non-transitory, computer-readable storage medium of claim 14, comprising instructions to:
establish the 5G network slicing configuration on the UE.

16. The at least one non-transitory, computer-readable storage medium of claim 14, wherein the UE has been configured by an original equipment manufacturer (OEM) to, in response to establishing the WiFi connection, automatically disable 5G SA connectivity.

17. The at least one non-transitory, computer-readable storage medium of claim 14, wherein causing the UE to be configured for 5G SA connectivity comprises:
detecting that 5G SA connectivity has been disabled; and
re-enabling 5G SA connectivity.

18. The at least one non-transitory, computer-readable storage medium of claim 14, wherein causing the UE to be configured for 5G SA connectivity comprises:
preventing the UE from automatically disabling 5G SA connectivity.

19. The at least one non-transitory, computer-readable storage medium of claim 14, configured to:
allow, in response to terminating the WiFi connection or a 5G connection, the UE to automatically disable 5G SA connectivity.

20. The at least one non-transitory, computer-readable storage medium of claim 14, wherein the indication that the 5G network slicing configuration is available comprises Network Slice Selection Assistance Information (NSSAI).
